(19) United States
(12) Patent Application Publication
(10) Pub. No.: US 2009/0205748 A1
(43) Pub. Date: Aug. 20, 2009

(54) MACHINE FOR FILLING CONTAINERS WITH AT LEAST ONE PRODUCT

(76) Inventor: Angelo ANSALONI, Crespellano (IT)

Correspondence Address: GOTTLIEB RACKMAN & REISMAN PC, 270 MADISON AVENUE, 8TH FLOOR, NEW YORK, NY, 10016-0601, US

(21) Appl. No.: 12/372,277

(22) Filed: Feb. 17, 2009

(30) Foreign Application Priority Data
Feb. 18, 2008 (EP) 08425098.4

(51) Int. Cl. A61J 3/07; B65B 1/38; G01F 11/04

(52) U.S. Cl. 141/250; 141/129; 53/282; 141/284; 222/314; 222/384

(57) ABSTRACT

On a continuous machine for filling containers with at least one product, each container is fed along a given path in time with a relative metering device, which withdraws the product from a tank, feeds the withdrawn product into the container, and has a piston and a cylinder movable axially with respect to each other; and a lock device provides for selectively locking the pistons and relative cylinders.

The present invention relates to a machine for filling containers with at least one product.

More specifically, the present invention relates to a machine for filling capsules with at least one powdered pharmaceutical product, to which the following description refers purely by way of example.

### BACKGROUND OF THE INVENTION

In the pharmaceutical industry, a machine for filling capsules with at least one powdered pharmaceutical product is known comprising a conveying device, which is movable continuously along a given path and has a number of pockets, each for receiving a respective bottom shell of a relative capsule; a container containing the product; and a metering wheel mounted to rotate continuously about a respective longitudinal axis.

The metering wheel has a number of metering devices, each of which is movable with the metering wheel along a portion of said path, in time with a relative bottom shell, to withdraw the product from said container and feed the product into the bottom shell, and comprises a cylinder and a piston moving vertically with respect to each other.

The cylinder and piston are moved with respect to each other by an actuating device, so that the piston first defines inside the cylinder a metering chamber filled with the product from the container, and then expels the product from the metering chamber into the relative bottom shell.

The actuating device comprises a first tappet fitted to the cylinder and cooperating with a first cam, a second tappet fitted to the piston and cooperating with a second cam, and push means to keep the second tappet in contact with the second cam.

Known machines of the above type have several drawbacks, mainly due to the metering devices being unable to prevent formation of the relative metering chambers and withdrawal of the product from the container when advanced in time with respective pockets containing no bottom shells, as, for example, when the machine is started up to feed the product into the container.

### SUMMARY OF THE INVENTION

It is an object of the present invention to provide a machine for filling containers with at least one product, designed to eliminate the aforementioned drawbacks.

According to the present invention, there is provided a machine for filling containers with at least one product, as claimed in the attached Claims.

### BRIEF DESCRIPTION OF THE DRAWINGS

A non-limiting embodiment of the present invention will be described by way of example with reference to the accompanying drawings, in which:

FIG. 1 shows a schematic side view, partly sectioned and with parts removed for clarity, of a preferred embodiment of the machine according to the present invention;

FIG. 2 shows a schematic longitudinal section of a first detail of the FIG. 1 machine;

FIG. 3 shows a schematic longitudinal section of a detail of FIG. 2;

FIG. 4 shows schematically the operating principle of the FIG. 1 machine;

FIG. 5 shows a schematic view in perspective of a second detail of the FIG. 1 machine;

FIGS. 6 and 7 show schematic longitudinal sections of the FIG. 5 detail in two different operating positions.

### DETAILED DESCRIPTION OF THE INVENTION

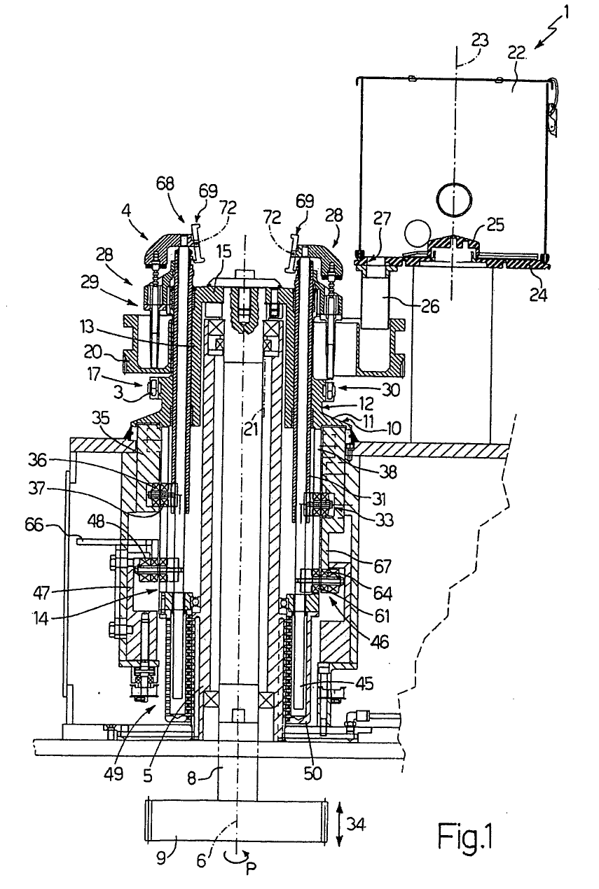

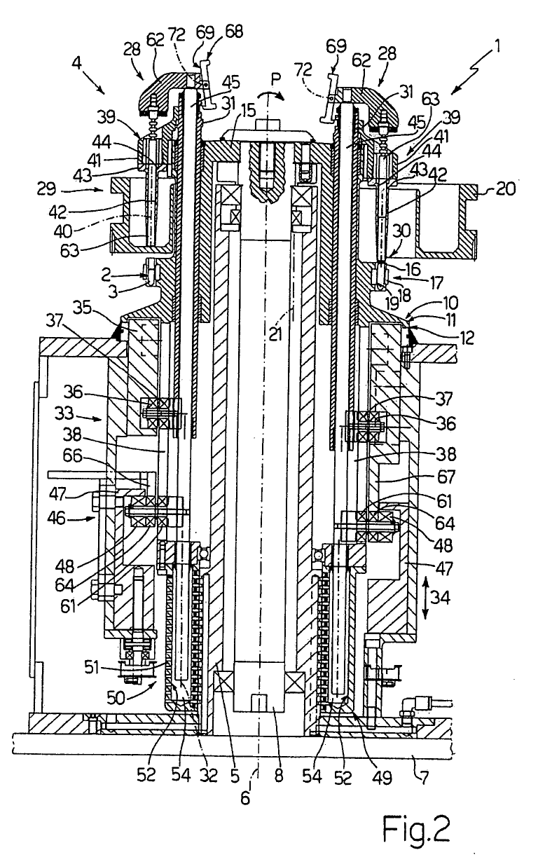

Number 1 in FIGS. 1 and 2 indicates as a whole a machine for filling known capsules 2 with a powdered pharmaceutical product. Each capsule 2 comprises a substantially cup-shaped bottom shell 3, and a top shell (not shown) fitted to bottom shell 3.

Machine 1 comprises a metering wheel 4, in turn comprising a tubular vertical upright 5, which has a longitudinal axis 6, extends upwards from a fixed frame 7 of machine 1, and is engaged by a shaft 8, which extends inside upright 5, coaxially with axis 6, and is connected in rotary manner to upright 5 to rotate continuously, with respect to upright 5 and under the control of a known actuating device 9, about axis 6.

Shaft 8 supports a feed drum 10 comprising a substantially cylindrical casing 11, which is coaxial with axis 6, is positioned with its concavity facing downwards, is bounded laterally by a wall 12 extending about upright 5 and comprising a narrow top portion 13 and a wide bottom portion 14, and is closed at one end by an end wall 15, which is substantially perpendicular to axis 6 and fixed to one end of shaft 8 projecting outwards of upright 5.

A sprocket 16 is formed on the outer surface of portion 13, is coaxial with axis 6, and forms part of a known conveying device 17 for feeding each bottom shell 3 along a given path P. Device 17 comprises a chain conveyor 18, which is looped about a number of sprockets (of which only sprocket 16 is shown in FIGS. 1 and 2) driven by device 9, and has a number of pockets 19, which are substantially cup-shaped with their concavity facing upwards, are equally spaced along conveyor 18, each receive a respective bottom shell 3 with its concavity facing upwards, and are fed continuously along path P by conveyor 18.

Wheel 4 also comprises an annular container 20 containing the powdered pharmaceutical product, and which extends over sprocket 16 and is fitted in rotary manner to frame 7 to rotate continuously, with respect to frame 7 and under the control of a known actuating device not shown, about a respective longitudinal axis 21 parallel to axis 6, and at an angular speed substantially differing from the angular speed of drum 10 and, therefore, of sprocket 16.

The powdered pharmaceutical product is fed into container 20 by a known hopper 22, which has a longitudinal axis 23 parallel to axes 6 and 21, is bounded at the bottom by an end wall 24 perpendicular to axis 23, houses a known mixing device 25 for mixing the pharmaceutical product, and has a feed conduit 26 extending downwards from hopper 22, projecting inside container 20, and fixed to hopper 22 at an opening 27 formed through wall 24 and parallel to axis 23.

Drum 10 has a number of metering devices 28 equally spaced about axis 6 and fed continuously about axis 6 by drum 10. Each device 28 is conveyed by drum 10 in time with a relative pocket 19 along a portion of path P extending between a pickup station 29, where device 28 withdraws a given quantity of pharmaceutical product from container 20, and a filling station 30, where device 28 feeds the withdrawn pharmaceutical product into relative bottom shell 3.

Each device 28 comprises a substantially cylindrical sleeve 31, which has a longitudinal axis 32 substantially parallel to axis 6, extends through portion 13 of drum 10, and is connected in axially-sliding manner to drum 10 to perform, with respect to drum 10 and under the control of an actuating device 33, straight movements in a direction 34 parallel to axes 6 and 32. Device 33 comprises a cam 35 common to sleeves 31 of all the metering devices 28; and, for each metering device 28, a relative tappet roller 36 carried by relative sleeve 31 and engaging cam 35.

Sleeve 31 is also connected in angularly-fixed manner to drum 10 by a tappet roller 37, which is carried by sleeve 31 and engages a relative slot 38, formed through portion 14 and parallel to direction 34, to prevent rotation of sleeve 31 about axis 32.

A cylinder 39 is fixed to the top end of sleeve 31, has a longitudinal axis 40 substantially parallel to axes 32, and comprises a wide top portion 41 and a narrow bottom portion 42 connected to each other at a shoulder 43, which is perpendicular to axis 40 and through which is formed at least one opening 44.

Device 28 also comprises a shaft 45, which is fitted inside sleeve 31, coaxially with axis 32, projects outwards of sleeve 31, and is connected in axially-sliding manner to sleeve 31 to perform, with respect to sleeve 31 and under the control of an actuating device 46, straight movements in direction 34.

Device 46 comprises a cam 47 common to shafts 45 of all the metering devices 28; and, for each metering device 28, a relative tappet roller 48, which is fitted to relative shaft 45, is smaller in diameter than the width of cam 47 measured parallel to direction 34, and is maintained contacting a top wall of cam 47 by a pneumatic push device 49 for pushing shafts 45 upwards in direction 34.

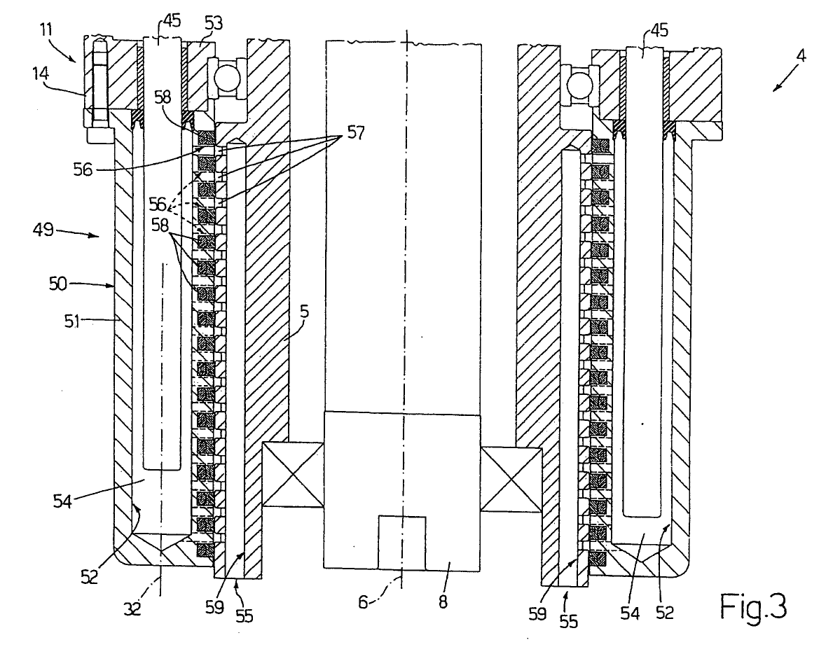

As shown in FIG. 3, device 49 comprises a substantially cylindrical casing 50, which is coaxial with axis 6, is fixed, with its concavity facing upwards, to the bottom end of casing 11, and is bounded laterally by a wall 51 extending about upright 5.

Casing 50 comprises a number of cavities 52, which are equal in number to metering devices 28, are equally spaced about axis 6 with the same spacing as devices 28, are formed in wall 51, parallel to direction 34, and are closed at the top by an annular flange 53 projecting radially inwards from the inner surface of drum 10 to define respective pneumatic chambers 54.

Each chamber 54 is engaged in sliding manner by the bottom end of a relative shaft 45, and communicates pneumatically with a known compressed-air pneumatic device (not shown) by means of a relative pneumatic circuit 55. Circuit 55 comprises a radial conduit 56 formed through wall 51; an annular manifold 57 formed on the outer surface of upright 5, coaxially with axis 6, and connected in fluidtight manner to conduit 56 by two annular seals 58 fitted to the inner surface of wall 51, coaxially with axis 6; and an axial conduit 59 formed in drum 10, parallel to direction 34, and connected permanently to said compressed-air pneumatic device (not shown).

In a variation not shown, conduits 56 are equally spaced about axis 6, are aligned circumferentially with one another, and all communicate with one annular manifold 57, which is connected in fluidtight manner to conduits 56 by two annular seals 58 on opposite sides of conduits 56, and communicates with one axial conduit 59 connected permanently to the compressed-air pneumatic device (not shown).

Each shaft 45 is connected in angularly-fixed manner to drum 10 by a tappet roller 61 carried by shaft 45 and engaging relative slot 38 to prevent rotation of shaft 45 about axis 32.

With the interposition of a supporting bracket 62, a substantially cylindrical piston 63 is fixed to the top end of shaft 45, projects downwards from bracket 62, engages relative cylinder 39 in sliding manner, and has a diameter approximately equal to but no larger than the diameter of narrow bottom portion 42 of cylinder 39.

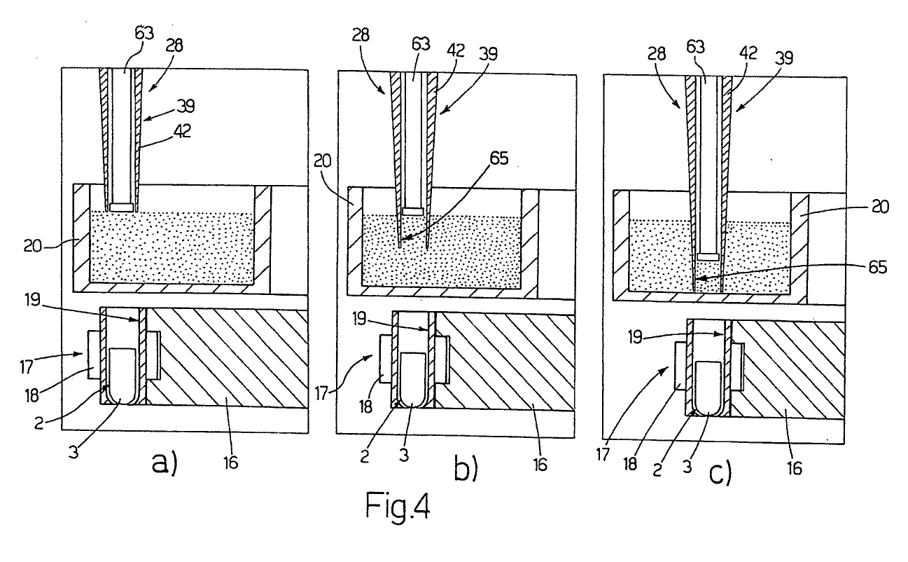

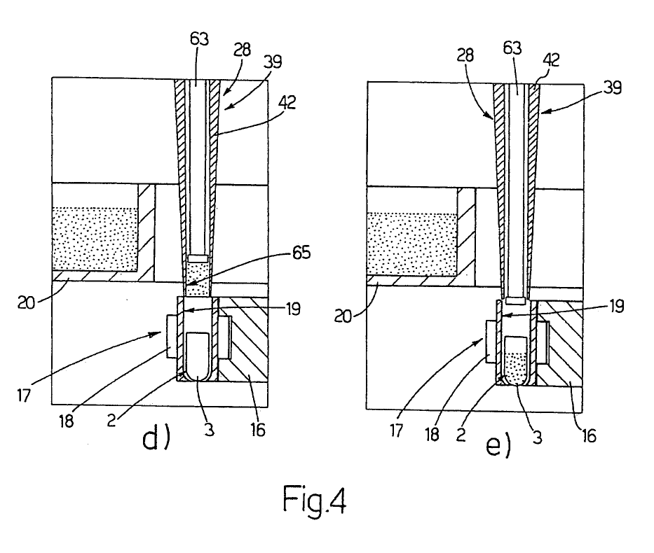

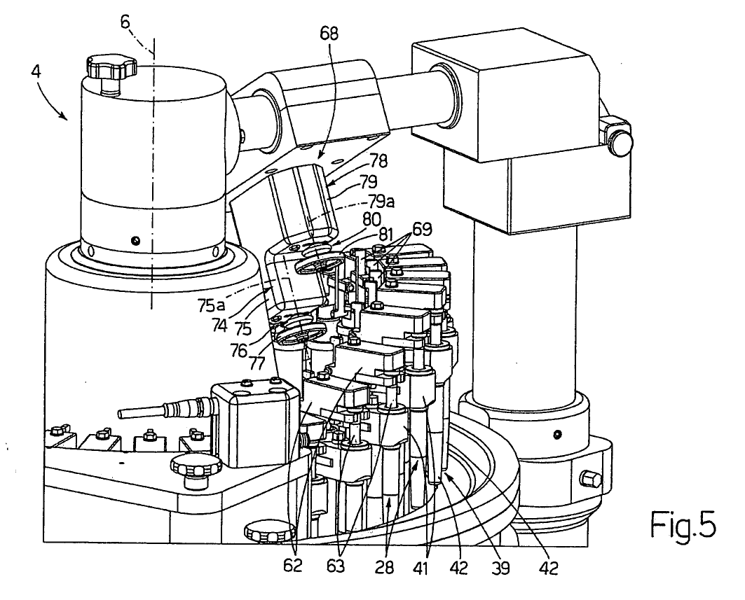

Operation of machine 1 will now be described with reference to FIGS. 2 and 4 and the filling of one bottom shell 3, and as of the instant in which the bottom shell 3 considered and the relative metering device 28 have been fed in time with each other into pickup station 29 (FIGS. 2 and 4a), and device 28 is positioned facing container 20.

At station 29, cylinder 39 and piston 63 of metering device 28 considered are first lowered in direction 34 by respective cams 35 and 47 into contact with the top surface of the product inside container 20 (FIG. 4a); piston 63 is then maintained contacting the top surface of the product by means of a further cam (not shown) projecting beneath cam 47 and engaged by a tappet roller 64 carried by shaft 45 (FIGS. 4a and 4b), while cylinder 39 is lowered into the product by cam 35 to define a metering chamber 65 corresponding to the correct amount of product to be withdrawn (FIG. 4b); cylinder 39 and piston 63 are again lowered by respective cams 35 and 47 in time with each other, so as to move cylinder 39 into contact with container 20 (FIG. 4c); and piston 63 is lowered further, to compact the product contained between cylinder 39 and piston 63 (FIG. 4c), by a cam 66 projecting beneath can 47 and engaged by roller 64.

At this point, by combining the movement of device 28 about axis 6 with the movement of cylinder 39 and piston 63 in direction 34, device 28 is disengaged from container 20 and fed to filling station 30 where, container 20 being mounted eccentrically with respect to drum 10, cylinder 39 and piston 63 are positioned facing relative pocket 19 (FIG. 4d).

Finally, piston 63 is lowered, to discharge the withdrawn product into relative bottom shell 3 (FIG. 4e), by a cam 67 projecting beneath cam 47 and engaged by roller 64.

With reference to FIGS. 1 and 2, to prevent formation of metering chambers 65 and withdrawal of the product from container 20 when metering devices 28 are fed through pickup station 29 in time with respective pockets 19 containing no bottom shells 3 (as, for example, when machine 1 is started up to feed the product into container 20), machine 1 comprises a lock device 68 for selectively locking pistons 63 to respective cylinders 39 to seal off respective bottom portions 42.

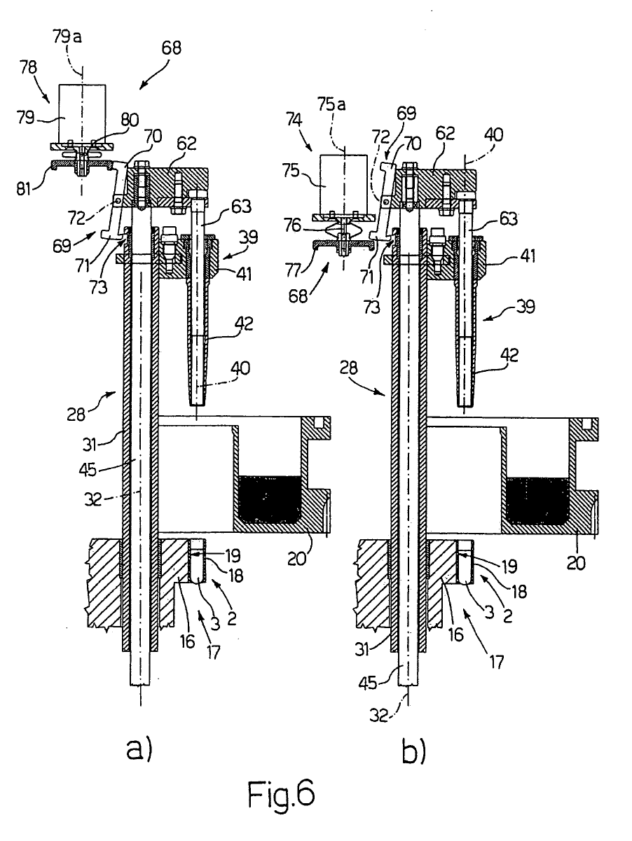

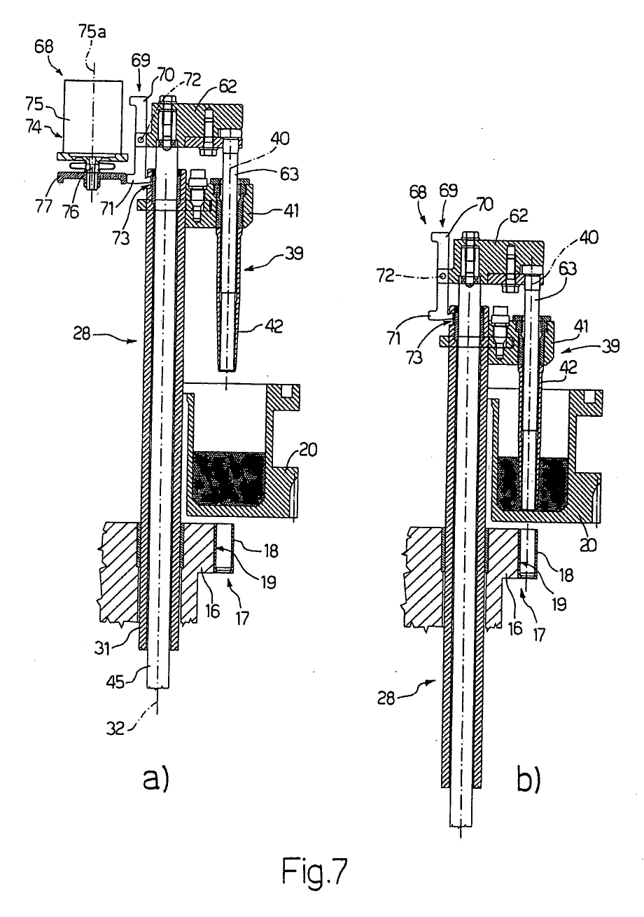

As shown in FIGS. 6 and 7, for each metering device 28, device 68 comprises a lock member defined by a rocker arm 69, which has a top arm 70 and a bottom arm 71, and is hinged to relative bracket 62 to oscillate, with respect to relative bracket 62 and about a hinge axis 72 crosswise to axis 6, between a lock position (FIGS. 7a and 7b), in which the free end of bottom arm 71 engages a corresponding seat 73, formed in the outer surface of relative sleeve 31, to lock relative cylinder 39 and piston 63 axially to each other and so prevent formation of relative metering chamber 65, and a release position (FIGS. 6a and 6b), in which relative cylinder 39 and piston 63 are movable axially with respect to each other to form relative metering chamber 65.

Rocker arms 69 are moved selectively from the release position to the lock position by a first actuating device 74 comprising, in the example shown, an electromagnetic actuator 75, which has a longitudinal axis 75a sloping with respect to axis 6, and comprises an output rod 76, which is fitted in rotary manner with a wheel 77, and is movable between a withdrawn position (FIG. 7a), in which wheel 77 is located inwards of the path of bottom arms 71, and an extracted position (FIG. 6b), in which wheel 77 is located outwards of the path of bottom arms 71.

Rocker arms 69 are moved selectively from the lock position to the release position by a second actuating device 78 located upstream from device 74 in the travelling direction of wheel 4 about axis 6, and comprising, in the example shown, an electromagnetic actuator 79, which has a longitudinal axis 79a parallel to axis 75a, and comprises an output rod 80, which is fitted in rotary manner with a wheel 81, and is movable between a withdrawn position (FIG. 6a), in which wheel 81 is located inwards of the path of top arms 70, and an extracted position (not shown), in which wheel 81 is located outwards of the path of top arms 70.

In variations not shown, electromagnetic actuators 75, 79 are replaced by pneumatic actuators or electric brushless motors.

In actual use, output rods 76, 80 of the two actuating devices 74, 78 are normally maintained in the extracted position. Output rod 76 of actuating device 74 is moved into the withdrawn position upon passage of a metering device 28 in time with a respective pocket 19 containing no bottom shell 33, so as to lock piston 63 to respective cylinder 39 and prevent formation of metering chamber 65; and output rod 80 of actuating device 78 is moved into the withdrawn position to release piston 63 from respective cylinder 39 and so form metering chamber 65.

In variations not shown:

rocker arms 69 are replaced by lock pins;

lock device 68 is replaced by two deflecting cams mounted at pickup station 29, and which are selectively inserted along the paths of respective tappet rollers 36 and 48, in lieu of respective cams 35 and 47, to keep pistons 63 in the powered position closing respective cylinders 39, and to move pistons 63 and respective cylinders 39 over container 20 to prevent withdrawal of the product from container 20; and

pneumatic push device 49 is replaced by at least one push spring fitted to each piston 63 and interposed between piston 63 and respective cylinder 39.

1) A machine for filling containers (3) with at least one product, the machine comprising conveying means (17) for feeding each container (3) continuously along a given path (P); a tank (20) containing the product; at least one metering wheel (4) mounted to rotate continuously about its longitudinal axis (6); a number of metering devices (28), which are movable with the metering wheel (4) along a portion of said path (P), in time with relative said containers (3), to feed the product into the relative containers (3), and each comprise a respective cylinder (39) and a respective piston (63); and actuating means (46) for moving each cylinder (39) and the relative piston (63) axially with respect to each other in a given direction (34); and being characterized by also comprising lock means (68) for selectively locking the cylinders (39) and relative pistons (63) in said direction (34).

2) A machine as claimed in claim 1, wherein, for each metering device (28), the lock means (68) comprise a seat (73) carried by one of the relative cylinder (39) and piston (63), and a lock member (69) carried by the other of the relative cylinder (39) and piston (63) and movable to and from a lock position, in which the lock member (69) engages the seat (73).

3) A machine as claimed in claim 2, wherein the lock means (68) also comprise an actuating device (74, 78) for moving the lock members (69) selectively between the lock position and a release position.

4) A machine as claimed in claim 3, wherein the actuating device (74, 78) comprises a first actuating device (78) for moving the lock members (69) selectively from the lock position to the release position; and a second actuating device (74) for moving the lock members (69) selectively from the release position to the lock position.

5) A machine as claimed in claim 4, wherein the first and second actuating device (78, 74) are arranged successively and in that order in a travelling direction of the metering wheel (4) about said axis (6).

6) A machine as claimed in claim 4, wherein each said first and second actuating device (78, 74) comprises a respective actuating member (81, 77) movable selectively between a work position, in which the actuating member (81, 77) is located inwards of a path of the lock members (69) about said axis (6), and a rest position, in which the actuating member (81, 77) is located outwards of said path.

7) A machine as claimed in claim 2, wherein the lock member (69) comprises a pin member.

8) A machine as claimed in claim 2, wherein the lock member (69) comprises a rocker arm.

9) A machine as claimed in claim 2, wherein each cylinder (39) and relative piston (63) are movable axially with respect to each other in said direction (34) to define a relative metering chamber (65) for a given amount of product; the metering chamber (65) having a substantially zero volume upon the relative lock member (69) moving into the lock position.

10) A machine as claimed in claim 1, wherein the actuating means (46) comprise first and second actuating means for respectively moving each cylinder (39) and relative piston (63) axially in said direction (34).

11) A machine as claimed in claim 10, wherein said second actuating means comprise at least one cam (47); at least one tappet (48) fitted to each piston (63) to cooperate with the cam (47); and push means (49) for keeping the tappets (48) in contact with the cam (47).

12) A machine as claimed in claim 11, wherein the push means (49) are pneumatic push means.

13) A machine as claimed in claim 11, wherein the push means (49) are elastic push means.

14) A machine for filling containers (3) with at least one product, the machine comprising conveying means (17) for feeding each container (3) continuously along a given path (P); a tank (20) containing the product; at least one metering wheel (4) mounted to rotate continuously about its longitudinal axis (6); a number of metering devices (28), which are movable with the metering wheel (4) along a portion of said path (P), in time with relative said containers (3), to feed the product into the relative containers (3), and each comprise a respective cylinder (39) and a respective piston (63); and actuating means (46) for moving each cylinder (39) and the relative piston (63) axially with respect to each other in a given direction (34), the actuating means (46) comprising a first cam (47), at least a first tappet (48) fitted to each piston (63) to cooperate with the first cam (47), and elastic push means for keeping the first tappets (48) in contact with the first cam (47); and being characterized by also comprising a stop device for selectively locking the cylinders (39) and relative pistons (63) in said direction (34).

15) A machine as claimed in claim 14, wherein the actuating means (46) also comprise a second cam (35), and at least a second tappet (36) fitted to each cylinder (39) to cooperate with the second cam (35); the stop device comprising a third and/or fourth cam movable selectively to and from relative work positions, in which the first and/or second tappets (48, 36) engage the third and/or fourth can to selectively lock the cylinders (39) and relative pistons (63) in said direction (34).

16) A machine as claimed in claim 14, wherein the stop device comprises lock means (68) for selectively locking the cylinders (39) and relative pistons (63) in said direction (34).

17) A machine as claimed in claim 14, wherein each cylinder (39) and relative piston (63) are movable axially with respect to each other in said direction (34) to define a relative metering chamber (65) for a given amount of product; the metering chamber (65) having a substantially zero volume upon activation of said stop device.
